(19) United States
(12) Patent Application Publication
(10) Pub. No.: US 2026/0335901 A1
(43) Pub. Date: Oct. 29, 2026

(54) METHOD AND DEVICE FOR GRINDING GRAIN

(71) Applicant: Eric FAVRE, St-Barthélemy (CH)

(72) Inventor: Eric FAVRE, St-Barthélemy (CH)

(21) Appl. No.: 19/120,172

(22) PCT Filed: Oct. 11, 2023
(86) PCT No.: PCT/EP2023/078245

§ 371 Date: Apr. 10, 2025

(30) Foreign Application Priority Data
Oct. 14, 2022 (EP) 22201661.0

(51) Int. Cl. B02C 4/06; A21D 13/02; B02C 4/08; B02C 4/30; B02C 4/42

(52) U.S. Cl. CPC B02C 4/06; A21D 13/02; B02C 4/08; B02C 4/30; B02C 4/42

(57) ABSTRACT

A machine for grinding cereals (1) comprising one or more crumbling devices (2), the crumbling device comprising a first comb roller (3) rotating about a first axis of rotation (A1) and a second comb roller (4) rotating about a second axis of rotation (A2), the first comb roller comprising a plurality of radii of first teeth (5) going around the axis of rotation (A1) and the second comb roller comprising a plurality of radii of second teeth (6) going around the second axis of rotation (A2), the first and second radii of teeth having complementary overlapping shapes, a width (W) of a gap between the teeth of the rollers being greater than 0, the first comb roller (3) and the second comb roller (4) being driven in rotation by one or more motors configured to drive the first teeth at a tangential velocity (V1) greater than a tangential velocity (V2) of the second teeth.

The present invention concerns a method for grinding plant grains, in particular cereal grains, for example for the preparation of bread. The invention also concerns the preparation of breads with ground cereal grains.

In methods for grinding cereal grains in order to produce flours for making breads, pastries and other foods prepared with cereal flours, millstones are used to reduce the cereal grains into small pieces by crushing and friction. The shearing and heating effects of the flour particles have the effect of causing the breakage and therefore the death of a majority of the cells on the surface of the particle.

In many conventional methods, the starch is separated from the germ and the pericarp. The starch ground into fine particles forms the white flour and for wholemeal flours, part or all of the particles of the pericarp and of the protein base and sometimes also of the germ are added.

Since the flour will then be cooked to produce bread or other flour-containing foods, it is not considered important to preserve the integrity of the cells on the surface of the flour particles. On the contrary, it is considered that the more living cells there are, the more activity there is, which can lead to the reduction in the shelf life of the flours. However, the method for heating the particles during the grain grinding method also leads to the destruction of some heat-sensitive compounds such as polyphenols. There is therefore some loss of taste in conventional flours following the grain grinding method.

In the food sector, there is a general and continuous desire to increase the taste qualities of the products, as well as other factors such as the shelf life and the ecological balance. The ecological balance must take into account the entire cycle starting from the cultivation of the grains to the final consumer product.

In view of the above, one object of the invention is to provide a device and a method for grinding cereal grains, or other grain-shaped plants such as chocolate beans, coffee gains, and corn grains, in order to increase the taste qualities of the products such as bread produced by using the ground grain flours.

It is advantageous to have flour with a long shelf life.

It is advantageous to have a method and device for grinding plant grains, such as cereal grains, which are environmentally friendly.

Another object of the invention is to provide bread with good taste quality.

It is advantageous to provide bread with a favorable overall ecological balance.

Objects of the invention are achieved by the independent claims. The dependent claims describe advantageous charcteristics of the invention.

The present invention describes a machine for grinding plant grains, such as cereal grains, comprising one or more crumbling devices, the crumbling device comprising a first comb roller rotating about a first axis of rotation and a second comb roller rotating about a second axis of rotation, the first comb roller comprising a plurality of radii of first teeth going around the axis of rotation (A1) and the second comb roller comprising a plurality of radii of second teeth going around the second axis of rotation (A2), the first and second radii of teeth having complementary overlapping shapes, a width W of a gap between the teeth of the rollers being greater than 0, the first comb roller and the second comb roller being driven in rotation by one or more motors configured to drive the first teeth at a tangential velocity V1 greater than a tangential velocity V2 of the second teeth.

In one advantageous embodiment, the first teeth have a tapered shape, viewed in section along a radial plane, with an angle of the tapered shape (a) in a range from 15 degrees to 45 degrees.

In one advantageous embodiment, the top of the teeth has a rounded shape.

In one advantageous embodiment, a tangential length T1 of the first teeth between a leading edge 11 and a trailing edge is greater than a tangential length T2 of the second teeth between a leading edge and a trailing edge.

In one advantageous embodiment, the tangential length ratio T2/T1 of the second teeth relative to the first teeth is in a range between 0.2 and 0.8.

In one advantageous embodiment, the first comb roller is configured to rotate at a tangential velocity V1 between 1 and 5 times the tangential velocity V2 of the second comb roller.

In one advantageous embodiment, the first tooth of the first comb roller comprises a leading edge inclined relative to a radial passing through the base of the leading edge in the direction of rotation of the first comb roller.

In one advantageous embodiment, the angle of inclination β1 of the leading edge relative to the radial of the first roller is between 5 degrees and 45 degrees, preferably between 10 degrees and 35 degrees.

In one advantageous embodiment, the second tooth of the second comb roller comprises a trailing edge inclined relative to a radial passing through the base of the trailing edge in the direction of rotation of the second comb roller.

In one advantageous embodiment, the angle of inclination φ2 of the trailing edge relative to the radial of the second roller is between 0 degrees and 40 degrees, preferably between 5 degrees and 30 degrees.

In one advantageous embodiment, the machine comprises a mechanism for adjusting the distance between the first axis of rotation A1 and the second axis of rotation A2 so as to adjust the width W of the gap between the first and second rollers.

In one advantageous embodiment, the machine comprises a plurality of crumbling devices, the upstream crumbling devices having a roller gap width W greater than downstream crumbling devices.

In one advantageous embodiment, the machine comprises a plurality of crumbling devices and conveying devices configured to transport grain crumbs between crumbling devices, as well as from the last crumbling device and an outlet of the machine.

In one advantageous embodiment, the machine comprises a cabin and a source of neutral gas such as nitrogen connected to the cabin filling it with neutral gas, the crumbling devices being disposed in the cabin.

In one advantageous embodiment, the cabin is hermetically sealed so as to be able to have an underpressure inside the cabin.

In one advantageous embodiment, the machine comprises a feeding device at the inlet of the machine, the feeding device comprising a metering distributor comprising a distribution roller with splines, the distribution roller being driven in rotation by a motor of the machine.

In one advantageous embodiment, the machine comprises at least one drying device, for example a device for drying grain crumbs by radiant heat and/or by ventilation, disposed between two crumbling devices.

The present invention also describes a method for grinding plant grains such as cereals, comprising a step of crumbling the grains between first teeth and second teeth spaced by a gap having a width W greater than 0 and smaller than the average grain size configured to break the grains or the grain crumbs into pieces by a shearing and folding effect, a major part of the breakage surface not being subjected to friction against the teeth.

In one advantageous embodiment, a machine according to one of the embodiments described above is used to crumble the grains.

The present invention also describes a cereal grain crumb flour obtained by a method according to any of the embodiments described above, comprising the following characteristics:
average size of thecrumbs: between 90 microns and 5 millimeters, preferably between 0.1 mm and 2 millimeters, for example from 0.2 mm to 1 mm;
number of intact (integral) cells on the crumb breakage surface, on average: greater than 30%, preferably greater than 40%, for example greater than 50%.

The present invention also describes a bread comprising cereal grain crumb flour described above in a dry-weight proportion from 5% to 50% of the total dry weight of the flours forming the bread, preferably between 20% and 40%, for example between 25% and 35%.

The present invention also describes a method for manufacturing bread according to the preceding embodiment, comprising:
the wetting and scalding of the crumb flour,
the preparation of a bread dough by adding the starch flour to the crumb flour in said proportion,
a baking of the bread dough in an oven.

Further aims and advantageous aspects of the invention will become apparent upon reading the following claims and/or detailed description of embodiments of the invention in relation to the figures, in which:

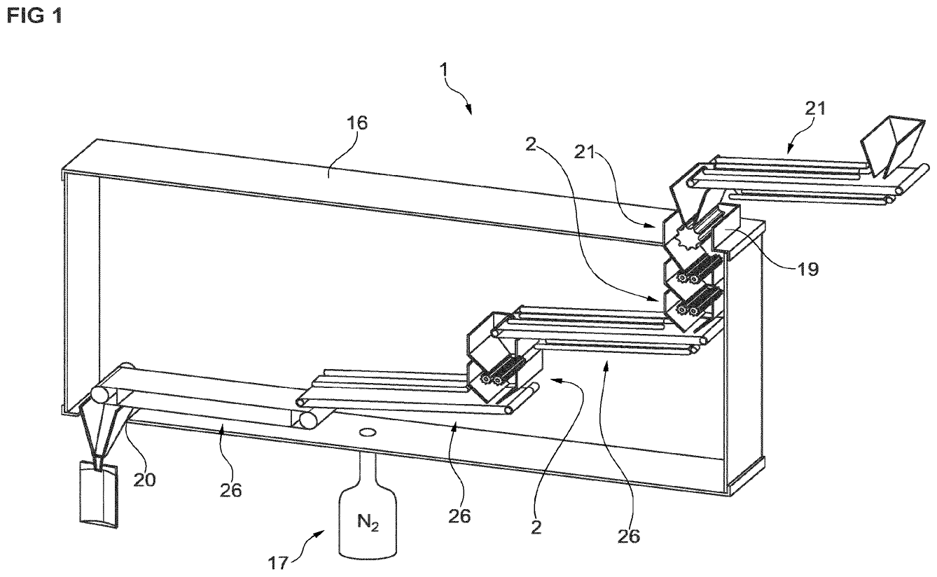

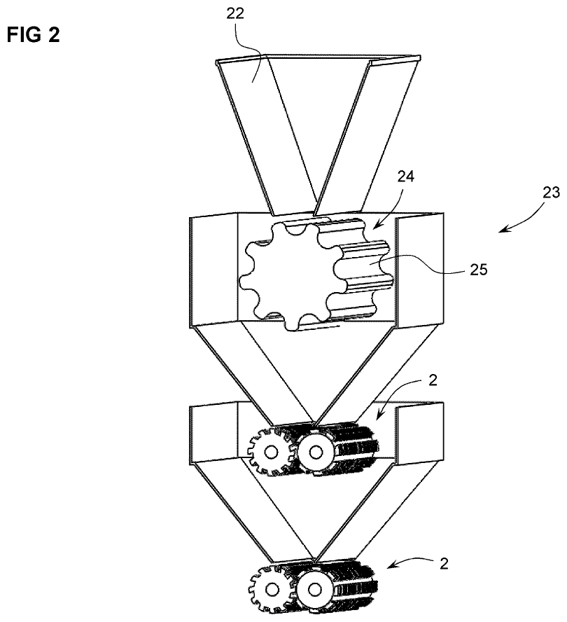

FIG. 1 is a schematic perspective view of a device for grinding grains according to one embodiment of the invention, with a cabin wall removed to see the interior;

FIG. 2 is a schematic view of part of the machine of FIG. 1 showing a feeding device and a crumbling device;

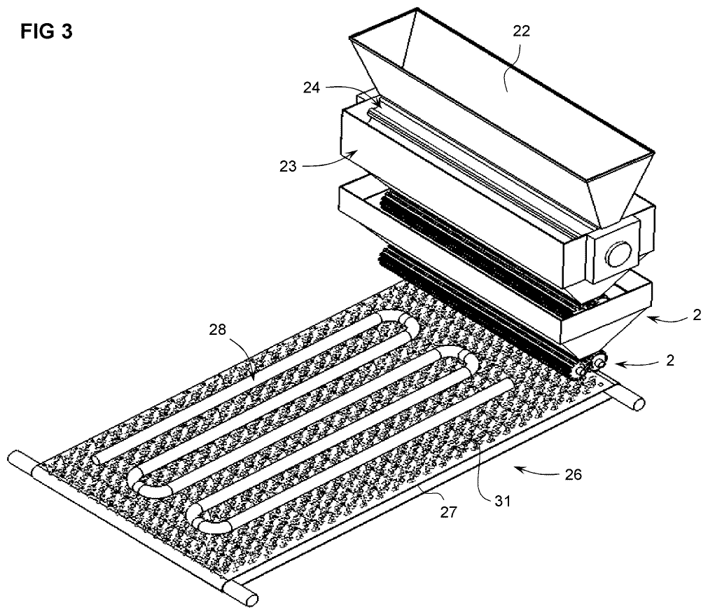

FIG. 3 is a perspective view of the device of FIG. 2 and of a conveying device and a drying device;

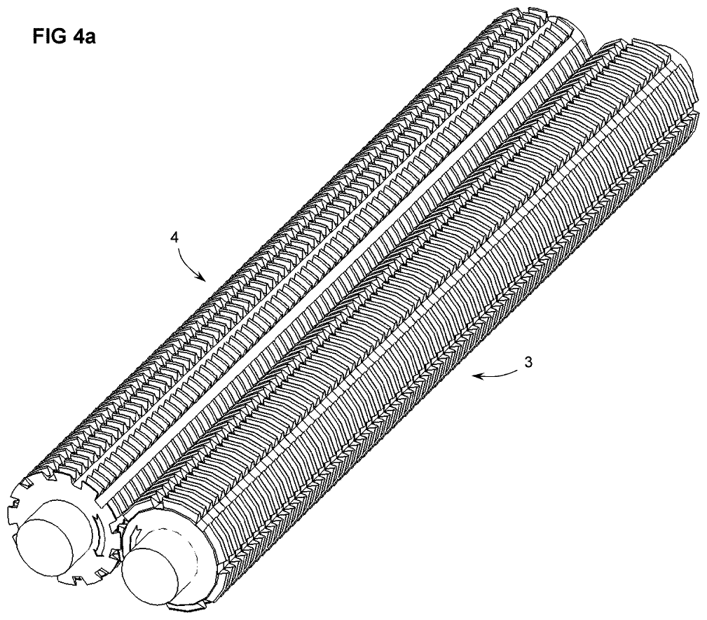

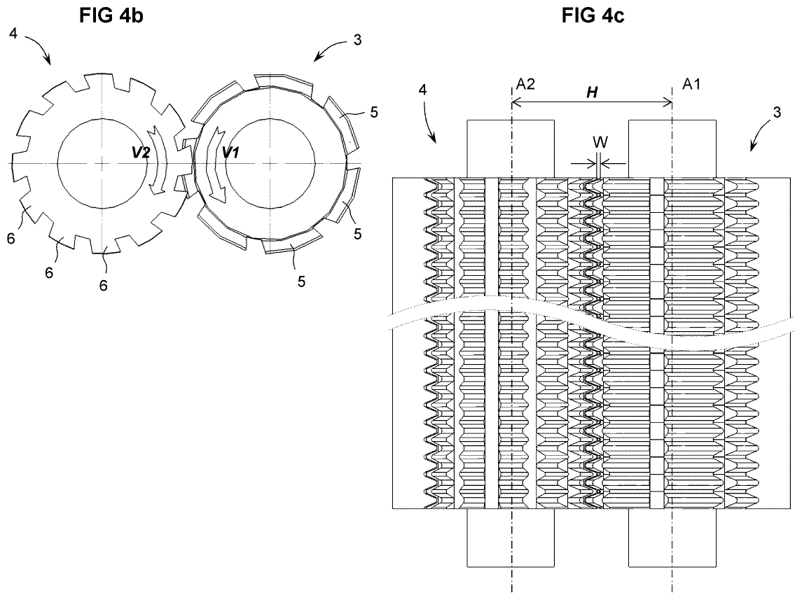

FIG. 4a is a schematic perspective view of a first comb roller and of a second comb roller of the crumbling device according to one embodiment of the invention;

FIG. 4b is a view in the direction of the axes of rotation of the first and second rollers;

FIG. 4c is a top view of the first and second rollers of FIG. 4a;

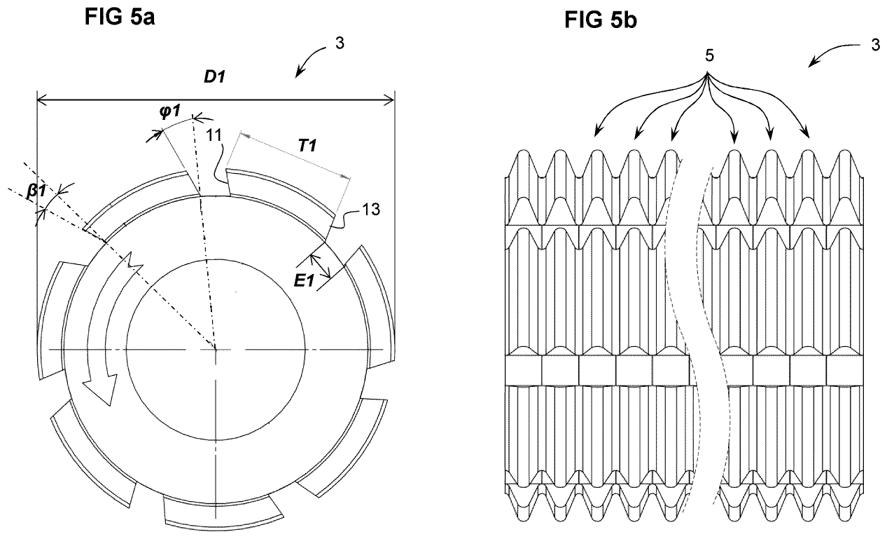

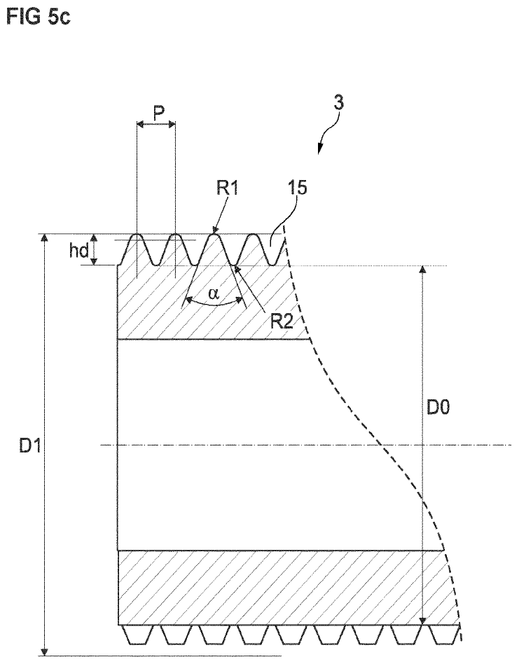

FIG. 5a is a view in the direction of the axis of rotation of the first comb roller;

FIG. 5b is a top view of the first roller of FIG. 5a;

FIG. 5c is a sectional view of the first roller of FIGS. 5a and 5b;

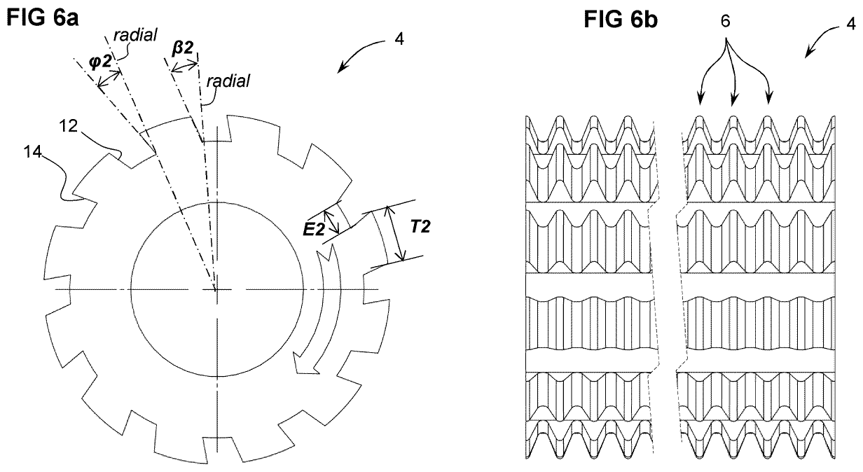

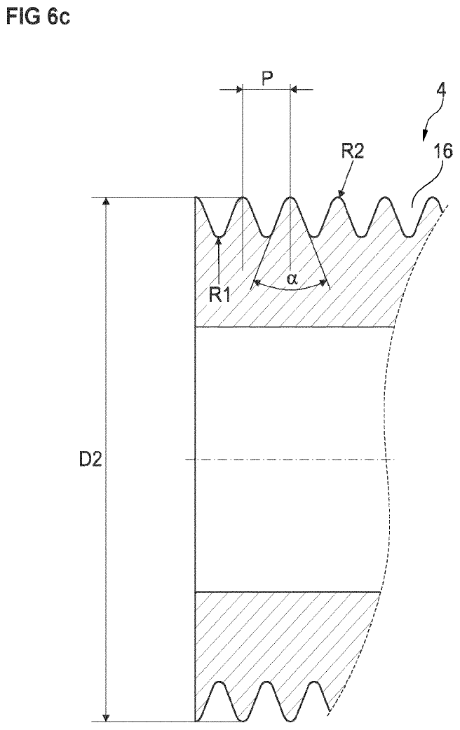

FIG. 6a is a view in the direction of the axis of rotation of the second comb roller;

FIG. 6b is a top view of the second roller of FIG. 6a;

FIG. 6c is a sectional view of the second roller of FIGS. 6a and 6b;

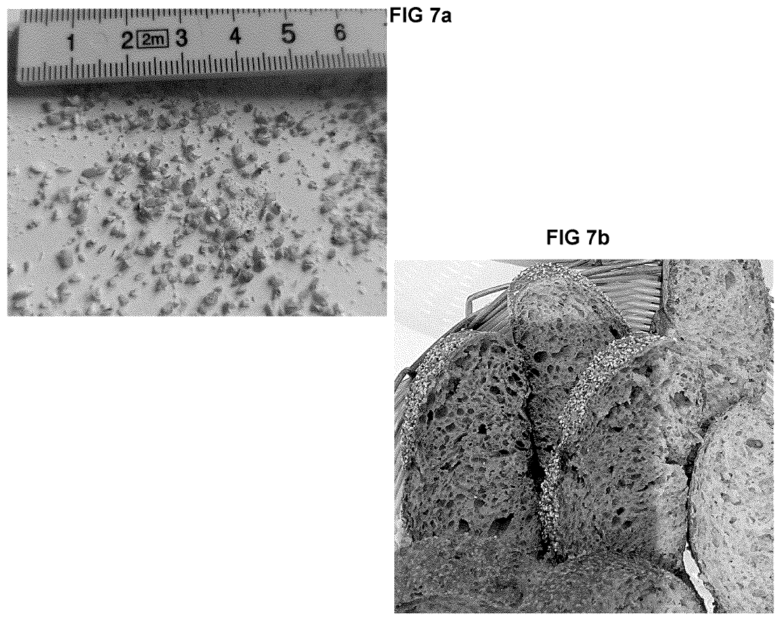

FIG. 7a is a photograph of cereal crumbs obtained by a method and a device according to the invention;

FIG. 7b is a photographic view of slices of bread made by using a crumb flour obtained by a method and a device according to the invention;

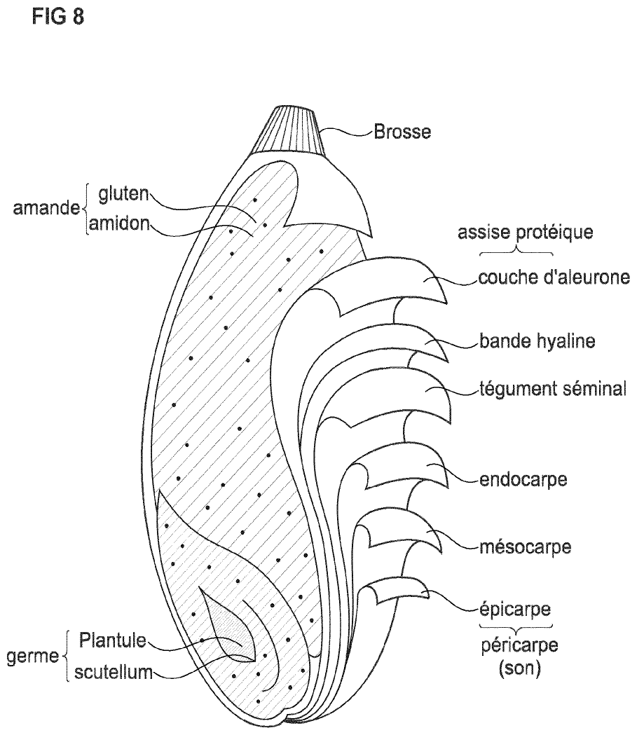

FIG. 8 is a known schematic view of the structure of a cereal grain, in this case wheat.

Referring to the figures, starting with FIGS. 1 to 3, a grain grinding machine 1 comprises at least one crumbling device 2 mounted in a cabin 16 having an inlet 19 and an outlet 20. The grinding machine may further comprise a source of neutral gas, for example a nitrogen source 17 connected to the cabin 16 configured to fill the cabin with the neutral gas in order to avoid or limit the oxidation of the crumbled grains present in the machine. The outlet 20 may comprise a channel or conduit connected directly to a container, bag or other form of receptacle in which the crumb flour exiting the machine is collected while remaining surrounded by the neutral gas, in order to preserve the flour enclosed in the containers at the end of the filling process.

The grinding machine also comprises conveying devices 26 for transporting the grain crumbs from the inlet 19 to the outlet 20 via one or more crumbling devices 2. The conveying device 26 may comprise one or more conveyor or vibrating belts, or vibrating trays, such conveying devices being known per se.

The machine 1 preferably comprises several crumbling devices 2 in order to reduce the size of the crumbs in stages. The crumbling devices may be placed one above the other as illustrated in FIG. 2, or separated by a conveying device 26 as illustrated in FIG. 1.

The feeding device 21 at the inlet 19 of the cabin 16 comprises a metering distributor 23 for metering the amount of grain introduced into the first crumbling device of the machine. The metering distributor 23 may be positioned under a funnel 22 to guide the grains to the metering distributor 23. In the illustrated example, the metering distributor 23 comprises a distribution roller 24 comprising splines 25 with a width and depth adapted to the size and type of grains to grind by the machine. The splines 25 limit the amount of grains that will be poured into the first crumbling device 2 when the distribution roller rotates, the rotational velocity of the distribution roller 24 also being controlled to adapt the amount of grains provided over time to the crumbling device.

Upstream of the metering distributor 23 and of the funnel 22 there may be a conveying device bringing the cereal grains from a cereal source.

The grinding machine 1 may also comprise one or more drying devices 28 configured to dry the grain crumbs, in particular during the transport of the crumbs by the conveying device 26. The drying of the grain crumbs may be performed between two crumbling devices 2 and/or between the last crumbling device and the outlet 20. The last crumbling device may also be configured for roasting the crumbs before they are packaged in the receptacles at the outlet 20 of the machine.

The crumbling device 2 comprises a first comb roller 3 and a second comb roller 4. The first comb roller 3 rotates about an axis of rotation A1 and is driven by a motor (not illustrated) configured to rotate the first comb roller at a rotational velocity V1 which may be varied according to the type of grains and the desired flow rate. Similarly, the second comb roller 4 is rotatably mounted about an axis of rotation A2 parallel to the first axis of rotation A1 and coupled to a second motor with a rotational velocity V2 which can be variable and controlled independently of the rotational velocity V1 of the first comb roller 3. In some embodiments, it is also possible to have a single rotation motor coupled to the two crumbling rollers by a transmission having a fixed or variable ratio so as to have a velocity of the first roller different from the velocity of the second roller.

The first comb roller 3 comprises a plurality of radi of first teeth 5 disposed circularly about the axis of rotation A1. The adjacent radii of first teeth are separated by a pitch distance P. The second comb roller 4 also comprises a plurality of radii of second teeth 6 disposed about the axis of rotation A2, also separated between adjacent radii by a pitch P. The shape of the first teeth and tooth recesses as well as the shape of the second teeth and tooth recesses are complementary so that the first teeth and the second teeth can overlap/interlock.

The first teeth and second teeth each have a tapered shape with a rounded top, complementary to a flared shape with a rounded recess 15 and 16 of the lateral tooth space. The tapered shape, taken in section orthogonal to the axis of rotation, has an angle α preferably between 15 degrees and 55 degrees (15°<α<) 55°.

The radius of the rounding R1 and R2 are preferably complementary between 0.5 mm and 2 mm (0.5 mm<R1<2 mm and 0.5 mm<R2<2 mm).

In the example illustrated, the maximum diameter D1 of the first roller is identical or close to the maximum diameter D2 of the second roller, however it can be envisaged to have the diameter of the first roller D1 different from the diameter of the second roller D2.

The machine comprises an adjustment system (not illustrated) of the support of the first and second rollers of the crumbling device to adjust the distance between the axes of rotation H and thus adjust the roller gap width W therefore corresponding to the width of the gap between the teeth of the rollers.

When the machine comprises several crumbling devices 2, the roller gap width W of the crumbling device downstream is set so as to be smaller than the roller gap width W of the crumbling device located upstream. The successive crumbling devices therefore reduce the size of the produced flour crumbs.

The first teeth forming the circonference of the first comb roller 3 each extend over a circular sector between a leading edge 11 and a trailing edge 13 having a tangential length T1. The first teeth are separated from each other by a circular spacing sector having a tangential length E1. The length of the spacing is preferably shorter than the length of the tooth T1>E1.

For a first roller with a diameter D1 of about 4 to 20 cm, the tangential length T1 of the first tooth would be for example of the order of 1 to 6 cm. The length of the first tooth T1 as well as the spacing length E1 of the first teeth can be different from the tangential length T2 of the second tooth of the second roller respectively from the tangential spacing length E2 between the second teeth of the second roller.

In one advantageous embodiment, the tangential length T2 of the second teeth of the second roller is smaller than the tangential length T1 of the first teeth of the first roller T1>T2.

Preferably, the ratio T2/T1 between the tangential length T2 of the second teeth and the tangential length T1 of the first teeth is between 0.2 and 0.8 (0.2<T1/T2<0.8).

The leading edge 11 of the first teeth 5 is inclined, in the direction of rotation, relative to a radial passing through the point of minimum radius of the leading edge (i.e. at the base of the tooth). The angle β1 of the leading edge relative to the radial (of the first roller) is in one embodiment between 5 and 45 degrees (5°<β1<45°), preferably between 10 and 35 degrees (10°<β1<35°).

The trailing edge 13 of the second teeth 5 is inclined, in the direction of rotation, relative to a radial passing through the point of minimum radius of the trailing edge (i.e. at the base of the tooth). The angle φ2 of the trailing edge relative to the radial (of the first roller) is in one embodiment between 0 and 40 degrees (0°<φ2<40°), preferably between 5 and 30 degrees (5°<φ2<30°).

The first roller is driven in rotation at a rotational velocity Vr1 resulting in a tangential velocity V1 of the first teeth greater than the tangential velocity V2 of the second teeth of the second roller driven at a rotational velocity Vr2, with the consequence that the leading edges 11 of the first teeth pinch the cereal grains against the trailing edge 14 of the second teeth taking into account the width space W of the rollers 3, 4 gap. A seed wedged between the leading edge 11 of a first tooth 5 and the trailing edge 14 of a second tooth 6, is subjected to a shearing and folding and tensile force. These forces that tear the seed due to the configuration of the teeth and of the spacing, have the effect of separating parts of the grains into pieces, leaving a majority of the cells on the breakage surface intact since there is no direct friction against a large part of the breakage surface. It is unavoidable that some cells undergo breakage by shear and friction, in particular the parts in direct contact with the teeth, however a large part of the breakage surface does not come into contact with the teeth, in any case with a much lower friction and crushing force than in traditional millstone systems, so as to preserve the integrity of a good part of the cells present in the torn surface.

When the grains are crumbled in a first phase, it is advantageous to dry these crumbs in order to improve the quality of the breakage in a subsequent crumbling phase to produce smaller crumbs. The drying method can be performed by the drying device 28 disposed along the conveying device 26 between two crumbling devices 2. The drying device can for example comprise a radiant heating body and/or a blast of dry and/or hot gas through the grain crumbs.

In one embodiment, the cabin 16 can be hermetically sealed so as to be able to have an underpressure inside the cabin. This underpressure can be advantageous for drying the crumbs more quickly.

The rotation of the two rollers 3, 4, so as to have a tangential velocity component at the interface between the rollers downwards, ensures that the upstream grains or crumbs pass through the interface between the first comb roller 3 and the second comb roller 4. This prevents the grains and crumbs from accumulating above the rollers.

The angle φ1 and the shape of the trailing edge 14 of the first teeth (of the first roller) and the angle 32 and the shape of the leading edge 12 of the second teeth (of the second roller) are of less importance than the leading edge of the first teeth and the trailing edge of the second teeth. In embodiments, the angles of the trailing edge 14 of the first teeth and of the leading edge 12 of the second teeth may vary, in the direction of rotation, for example between 0° and 40° (0°<φ1<40° and 0°<β2<40°), relative to the radial passing through the base of the edge in question.

Since the first roller rotates faster than the second roller, there is an advantage in the tangential length T2 of the circular sector of the teeth of the second roller being smaller than the tangential length T1 of the circular sector of the teeth of the first roller. This ensures that the leading edges 11 of the first teeth intersect the trailing edges 14 of the second teeth and wedge the grains to break them.

The radial height hd of the first and second teeth, in one embodiment, in particular for grinding cereal grains, is in the order of magnitude from 2 mm to 20 mm (2 mm<hd<20 mm), preferably in the order of magnitude from 3 mm to 10 mm (3 mm<hd<10 mm).

During the crumbling, the grains or the grain crumbs are retained by the trailing edges 14 of the second comb roller 4 since this second roller rotates more slowly than the first roller while the teeth of the first roller catch the grains and crumbs during the passage through the trailing edge to cause the breakage of the grains and crumbs. The grains and crumbs driven by the first roller 3 are projected onto the second roller 4 and then caught by subsequent teeth during the rotation of the first roller which goes faster than the second roller.

The grinding machine may further comprise a device for separating crumbs of different sizes using a vibrating screen device with a grid retaining crumbs of a certain size and allowing crumbs of a smaller size to pass through to a conveying or receiving system. The separation of crumb sizes may allow better control of crumb flour metering and composition for the subsequent production of breads or other flour-based foods.

The table below summarizes the preferred value ranges of the parameters for embodiments of the invention:

| | | Preferential | |
|---|---|---|---|
| Parameter | Max range | range | Optimal range |
| Lateral tooth distance (pitch) P | 2 mm-20 mm | 3 mm-15 mm | 4 mm-10 mm |
| Angle of the tapered shape of the | 15°-45° | | |
| teeth α | | | |
| Width of the roller gap (between the | 0.09 mm-5 mm depending on the size of the grains | | |
| teeth of the rollers) W | and crumbs and position of the crumbling device | | |
| Diameter of the first roller D1 | 3 cm-40 cm | 4 cm-30 cm | 4.5 cm-7 cm |
| Diameter of the second roller D2 | 3 cm-40 cm | 4 cm-30 cm | 4.5 cm-7 cm |
| Angle of the tapered shape of the | 15°-55° | 25°-50° | 35°-50° |
| teeth α | | | |
| Radius of the rounding of the top R1 | 0.5 mm-2 mm | | |
| Radius of the rounding of the top R2 | 0.5 mm-2 mm | | |
| Angle of the leading edge (relative to | 5°-45° | 10°-35° | 15°-30° |
| the radial) of the first roller β1 | | | |
| Angle of the trailing edge (relative to | 0°-40° | | |
| the radial) of the first roller φ1 | | | |
| Angle of the leading edge (relative to | 0°-40° | | |
| the radial) of the second roller β2 | | | |
| Angle of the trailing edge (relative to | 0°-40° | 5°-30° | 10°-20° |
| the radial) of the second roller φ2 | | | |
| Tangential length of a tooth of the first | 0.5 cm-10 cm | 1 cm-6 cm | 1.5 cm-2.5 cm |
| roller T1 | | | |
| Tangential length of the tooth space of | 1 mm-20 mm | 3 mm-10 mm | 4 mm-8 mm |
| the first roller E1 | | | |
| Tangential length ratio T2/T1 | 0.1-1 | 0.2-0.8 | 0.4-0.8 |
| Tangential length of the tooth space of | 1 mm-20 mm | 3 mm-10 mm | 4 mm-8 mm |
| the second roller E2 | | | |
| Radial height hd of the first and | 2 mm-20 mm | 3 mm-10 mm | 4 mm-6 mm |
| second teeth | | | |
| Tangential velocity of the teeth of the | 0.04 m/s-7 m/s | 0.1 m/s-5 m/s | 0.1 m/s-4 m/s |
| first roller V1 | | | |
| Velocity ratio V1/V2 | 1-5 | 1.5-5 | 1.5-4 |

Advantageously, since the grain crumbs ground according to the invention have a proportion of living cells on the surface of the crumbs greater than in conventional methods where friction and crushing as well as heating of the rubbed surface destroy the majority of the cells, the grain crumbs produced according to the method of the invention can absorb more water. Indeed, the living cells can accumulate and retain more water than the dead cells.

When making doughs and in particular for bread dough, the grain crumbs ground by a method according to the invention are first wetted in order to increase the water content of the crumb flour and then boiled in order to kill the cells when they are saturated with water. The scalded crumb flour can then be mixed with conventional flours, for example white flour whose starch and gluten content allows binding the dough.

It is advantageous to make bread with a cereal grain crumb flour produced according to the invention by mixing it with a baker's white flour in a dry weight ratio from 5 to 50% of crumb flour. A white wheat flour for bread has the following typical characteristics: particles of average size of about 90 to 100 microns, typical moisture content of about 14.5 max %.

By having a proportion of cereal grain crumb flour made according to the method of the invention in the indicated proportions, the taste qualities of the bread as well as its shelf life are improved.

The cereal grain crumbs such as wheat, rye, spelt, barley, oat grains are advantageously prepared by scalding in water at about 90 °C and they absorb much more water than the traditional starch flours.

Thus, they swell more and the released oxygen captures the different polyphenols and other aromas. For example, when baking a bread composed of a greater or lesser amount of this crumbled flour according to embodiments of the invention, the still living cells are neutralized and the bread obtained is more naturally flavored, heavier and keeps much longer.

The greater the amount of crumbled flour in the dough, the less it is necessary to add salt and the better the bread will be for the health of the consumer.

### Example of Rye Bread

One bread-one dough 400 gr
./. Weight loss during baking 72 gr
Final weight of rye bread 328 gr

### Composition:

Semi-white flour (starch) 84%
Flour crumbled according to the invention 16%
Water dissolved in the starch flour 40%
Water dissolved in the crumbled flour 62.5%
Crumbled rye flour is very advantageous for the baker, because the bread is heavier (more water) for the same amount of flour.

### Example of Spelt or Durum Wheat Bread

One bread-one dough 400 gr
./. Weight loss during baking 72 gr
Final weight of the spelt 328 gr
or durum wheat bread

### Composition:

Semi-white flour (starch) 77%
Flour crumbled according to the invention 23%
Water dissolved in starch flour 40%
Water dissolved in the crumbled flour 62.5%
As with crumbled rye flour, the spelt and durum wheat flours are also beneficial.

In these two examples, the bread is 20 to 30 cm long, 7 to 10 cm wide and 8 to 10 cm high. The alveoli of the bread white part are of 2 to 5 mm and are whole. Under the effect of pressure, they keep all their initial shapes. The crust of the bread has been hardened by cooking and is of medium roughness, but resistant to pressure. The breads can therefore be stacked without deformation. If the dough is covered with spelt crumbs, the upper crust of the bread tears during baking to give a fresh appearance. The crust of the bread is crispy and protects the interior white part, which is very aromatic, without any additives.

Since the white part of the bread with crumbled flour according to the invention is more moist (amount of water absorbed by the cereal crumbs), the latter quickly returns to its initial shape before pressure.

The photo (FIG. 7b) of the slices of bread according to the second example illustrates the lightness of the white part and the thickness of the protective crust.

### Example of the Characteristics of a Crumb Flour According to One Embodiment

Wheat, spelt and/or rye grains are composed of approximately (see FIG. 8):
85% starch contained in the kernel of the grain;
6% bran which is the protective pericarp of the grain, without nutritional value, but useful for intestinal transit;
9% protein bases (aleurone+hyaline layer+seed coat+germ), which contain many vitamins and food supplements very useful for human health;
and finally
The germ or seedling, which are as many living cells of the plant grains.

The particles of durum wheat crumbling (example illustrated in FIG. 7a) can vary for example from 100 μm to 3 mm. The largest particles come from the kernel of the grain which resists crumbling without pressure, unlike traditional mills, and the finest particles come from the protein base varying for example from 50 to 150 μm.

During the preparation of this crumbled flour by scalding at about 90-100 °C, these cells absorb a large amount of water and swell much more than the starch cells. The oxygen in the water tears the proteins from the cells and develops the aromas and virtues of these grains. During baking, the living cells, already damaged by scalding, are destroyed and slow down the development of mold or other alterations, to increase the shelf life of the bread. In addition, the higher moisture of the white part of the bread with crumb flour according to the invention, compared to traditional bread, advantageously prolongs its shelf life.

### LIST OF THE REFERENCES IN THE FIGURES

Machine for grinding grains (e.g. cereals) 1
   Cabin 16
   Source of neutral gas (nitrogen) 17
   Inlet 19
   Outlet 20
   Feeding device 21
      Funnel 22
      Metering distributor 23
         Distribution roller 24
         Splines 25
   Conveying device 26
      conveyor belt/vibrating belt 27
   Crumbling device 2
      First comb roller 3
         Axis of rotation A1
         First teeth 5
         tapered shape
         rouned top 9
         circular sector of a tooth
         circular spacing sector
         leading edge 11
         trailing edge 13
         Lateral tooth space 7
         Flared shape
         Rounded recess 15
      Second comb roller 4
         Axis of rotation A2
         Second teeth 6
         tapered shape
         Rounded recess 10
         circular sector of a tooth
         tangential spacing circular sector
         leading edge 12
         trailing edge 14
         tooth space 8
         tapered shape
         Rounded recess 16
   Drying device 28
   Cereal grains 30
      Kernel (Starch, Gluten)
         Cells
      Germ
      Pericarp
      Protein base
      Comb
      Crumbs 31

### Parameters

Lateral tooth distance (pitch) P
Width of the roller gap (between the teeth of the rollers) W
Diameter of the first roller D1
Diameter of the second roller D2
Angle of the tapered shape of the teeth α
Tangential length of a tooth of the first roller T1
Tangential length of the tooth space of the first roller E1
Tangential length of a tooth of the second roller T2
Tangential length of the tooth space of the second roller E2
Radius of the rounding of the top R
Angle of the leading edge (relative to the radial) of the first roller β1
Angle of the trailing edge (relative to the radial) of the first roller φ1
Angle of the leading edge (relative to the radial) of the second roller β2
Angle of the trailing edge (relative to the radial) of the second roller φ2
Angle of the circular sector of a tooth of the first roller σ1
Angle of the circular sector of the tooth space of the first roller ω1
Angle of the circular sector of a tooth of the second roller σ2
Angle of the circular sector of the tooth space of the second roller ω2
Tangential velocity (at maximum diameter) of the first roller V1
Tangential velocity (at maximum diameter) of the second roller V2
Velocity ratio V1/V2

1. A machine for grinding grains comprising a plurality of crumbling devices, each crumbling device comprising a first comb roller rotating about a first axis of rotation (A1) and a second comb roller rotating about a second axis of rotation (A2), the first comb roller comprising a plurality of radii of first teeth going around the axis of rotation (A1) and the second comb roller comprising a plurality of radii of second teeth going around the second axis of rotation (A2), the first and second radii of teeth having complementary overlapping shapes, a width (W) of a gap between the teeth of the rollers being greater than 0, the first comb roller and the second comb roller being driven in rotation by one or more motors configured to drive the first teeth at a tangential velocity (V1) greater than a tangential velocity (V2) of the second teeth, the one or more upstream crumbling device(s) having a roller gap width (W) greater than the downstream crumbling device(s).

2. The machine according to claim 1, wherein the first teeth have a tapered shape, viewed in section along a radial plane, with an angle of the tapered shape (α) in a range of from 5° degrees to 45 degrees.

3. The machine according to claim 1, wherein the top of the teeth has a rounded shape.

4. The machine according to claim 1, wherein a tangential length (T1) of the first teeth between a leading edge and a trailing edge is greater than a tangential length (T2) of the second teeth between a leading edge and a trailing edge, the tangential length ratio (T2/T1) of the second teeth relative to the first teeth is being in a range between 0.2 and 0.8.

5. (canceled)

6. The machine according to claim 1, wherein the first tooth of the first comb roller comprises a leading edge inclined relative to a radial passing through the base of the leading edge in the direction of rotation of the first comb roller, the angle of inclination (β1) of the leading edge relative to the radial of the first roller being between 5 degrees and 45 degrees.

7. The machine according to claim 1, wherein the second tooth of the second comb roller comprises a trailing edge inclined relative to a radial passing through the base of the trailing edge in the direction of rotation of the second comb roller, for example the angle of inclination (φ2) of the trailing edge relative to the radial of the second roller being between 5° degrees and 40 degrees.

8. The machine according to claim 1, wherein it comprises a mechanism for adjusting the distance between the first axis of rotation (A1) and the second axis of rotation (A2) so as to adjust the width of the gap (W) between the first and second rollers.

9. The machine according to claim 1, comprising conveying devices configured to transport grain crumbs between crumbling devices, as well as from the last crumbling device and an outlet of the machine.

10. (canceled)

11. The machine according to claim 1, wherein it comprises a feeding device at the inlet of the machine, the feeding device comprising a metering distributor comprising a distribution roller with splines, the distribution roller driven in rotation by a motor of the machine.

12. The machine according to claim 1, wherein it comprises at least one drying device for drying grain crumbs by radiant heat and/or by ventilation, disposed between two crumbling devices, and optionally, at least one drying device configured for roasting the crumbs disposed before the outlet of the machine.

13. A method for grinding plant grains such as cereals using a machine comprising a crumbling device comprising a first comb roller rotating about a first axis of rotation (A1) and a second comb roller rotating about a second axis of rotation (A2), the first comb roller comprising a plurality of radii of first teeth going around the axis of rotation (A1) and the second comb roller comprising a plurality of radii of second teeth going around the second axis of rotation (A2), the first and second radii of teeth having complementary overlapping shapes, the first comb roller and the second comb roller being driven in rotation by one or more motors configured to drive the first teeth at a tangential velocity (V1) greater than a tangential velocity (V2) of the second teeth, the method comprising a step of crumbling the grains between the first radii of teeth and the second radii of teeth spaced by a gap having a width (W) greater than 0.09 mm and smaller than the average grain size configured to break the grains or the grain crumbs into pieces by a shearing and folding effect, a major part of the breakage surface not being subjected to friction against the teeth.

14. (canceled)

15. A cereal grain crumb flour obtained by a method according to claim 13, comprising the following characteristics:
average crumb size: between 0.1 mm and 2 millimeters;
number of intact (integral) cells at the crumb breakage surface, on average: greater than 30%.

16. A bread comprising cereal grain crumb flour according to claim 15 in a dry-weight proportion from 5% to 50% of the total dry weight of the flours forming the bread.

17. A method for manufacturing bread according to claim 16, comprising:
the wetting and scalding of the crumb flour,
the preparation of a bread dough by adding the starch flour to the crumb flour in said proportion,
a baking of the bread dough in an oven.

18. A machine for grinding grains comprising one or more crumbling devices, the crumbling device comprising a first comb roller rotating about a first axis of rotation (A1) and a second comb roller rotating about a second axis of rotation (A2), the first comb roller comprising a plurality of radii of first teeth going around the axis of rotation (A1) and the second comb roller comprising a plurality of radii of second teeth going around the second axis of rotation (A2), the first and second radii of teeth having complementary overlapping shapes, a width (W) of a gap between the teeth of the rollers being greater than 0, the first comb roller and the second comb roller being driven in rotation by one or more motors configured to drive the first teeth at a tangential velocity (V1) greater than a tangential velocity (V2) of the second teeth, wherein that the first tooth of the first comb roller comprises a leading edge inclined relative to a radial passing through the base of the leading edge in the direction of rotation of the first comb roller.

19. The machine according to claim 18, wherein the angle of inclination (β1) of the leading edge relative to the radial of the first roller is between 5 degrees and 45 degrees.

20. The machine according to claim 18, wherein the first teeth have a tapered shape, viewed in section along a radial plane, with an angle of the tapered shape (α) in a range from 15 degrees to 45 degrees.

21. The machine according to claim 18, wherein the top of the teeth has a rounded shape.

22. The machine according to claim 18, wherein a tangential length (T1) of the first teeth between a leading edge and a trailing edge is greater than a tangential length (T2) of the second teeth between a leading edge and a trailing edge, the tangential length ratio (T2/T1) of the second teeth relative to the first teeth being in a range between 0.2 and 0.8.

23. The machine according to claim 18, characterized in that the first comb roller is configured to rotate at a tangential velocity (V1) between 1 and 5 times the tangential velocity (V2) of the second comb roller.

24. The machine according to claim 18, wherein the second tooth of the second comb roller comprises a trailing edge inclined relative to a radial passing through the base of the trailing edge in the direction of rotation of the second comb roller, for example the angle of inclination (φ2) of the trailing edge relative to the radial of the second roller being between 5° degrees and 40 degrees.

25. The machine according to claim 18, wherein it comprises a mechanism for adjusting the distance between the first axis of rotation (A1) and the second axis of rotation (A2) so as to adjust the width (W) of the gap between the first and second rollers.

26. (canceled)

27. (canceled)

28. The machine according to claim 18, wherein it comprises a feeding device at the inlet of the machine, the feeding device comprising a metering distributor comprising a distribution roller with splines, the distribution roller driven in rotation by a motor of the machine.

29. The machine according to claim 18, wherein it comprises at least one drying device for drying grain crumbs by radiant heat and/or by ventilation, disposed between two crumbling devices, and optionally, at least one drying device configured for roasting the crumbs disposed before the outlet of the machine.

30. A machine for grinding grains comprising one or more crumbling devices, the crumbling device comprising a first comb roller rotating about a first axis of rotation (A1) and a second comb roller rotating about a second axis of rotation (A2), the first comb roller comprising a plurality of radii of first teeth going around the axis of rotation (A1) and the second comb roller comprising a plurality of radii of second teeth going around the second axis of rotation (A2), the first and second radii of teeth having complementary overlapping shapes, a width (W) of a gap between the teeth of the rollers being greater than 0, the first comb roller and the second comb roller being driven in rotation by one or more motors configured to drive the first teeth at a tangential velocity (V1) greater than a tangential velocity (V2) of the second teeth, the machine comprising a cabin and a source of neutral gas such as nitrogen connected to the cabin filling it with neutral gas, the crumbling device(s) being disposed in the cabin.

31. The machine according to claim 30, wherein the cabin is hermetically sealed so as to be able to have an underpressure inside the cabin.

32. (canceled)

33. (canceled)

34. (canceled)

35. (canceled)

36. (canceled)

37. (canceled)

38. (canceled)

39. The machine according to claim 30, wherein it comprises a plurality of crumbling devices, the upstream crumbling devices having a roller gap width (W) greater than downstream crumbling devices.

40. The machine according to claim 30, comprising a plurality of crumbling devices and conveying devices configured to transport grain crumbs between crumbling devices, as well as from the last crumbling device and an outlet of the machine.

41. The machine according to claim 30, wherein it comprises a feeding device at the inlet of the machine, the feeding device comprising a metering distributor comprising a distribution roller with splines, the distribution roller being driven in rotation by a motor of the machine.

42. The machine according to claim 30, wherein it comprises at least one drying device for drying grain crumbs by radiant heat and/or by ventilation, disposed between two crumbling devices, and optionally, at least one drying device configured for roasting the crumbs disposed before the outlet of the machine.
